(19) United States
(12) Patent Application Publication
(10) Pub. No.: US 2009/0075008 A1
(43) Pub. Date: Mar. 19, 2009

(54) Photocurable composition for the formation of pressure-sensitive adhesive layer and dicing tape produced using the same

(76) Inventors: Yong Ha Hwang, Bucheon-si (KR); Chang Bum Chung, Yongin-si (KR); Gyu Seok Song, Hwaseong-si (KR); Baek Soung Park, Suwon-si (KR); Seung Jip Choi, Uiwang-si (KR); Kyoung Jin Ha, Seoul (KR)

Correspondence Address: LEE & MORSE, P.C., 3141 FAIRVIEW PARK DRIVE, SUITE 500, FALLS CHURCH, VA, 22042, US

(21) Appl. No.: 12/230,427

(22) Filed: Aug. 28, 2008

(30) Foreign Application Priority Data
Aug. 31, 2007 (KR) 10-2007-0088323

(51) Int. Cl. B32B 33/00; C08L 33/00

(52) U.S. Cl. 428/41.7; 522/99; 522/46; 522/33; 522/36

(57) ABSTRACT

A photocurable composition for a pressure-sensitive adhesive layer includes a pressure-sensitive adhesive binder, a reactive acrylate having a silicone backbone, a thermal curing agent, and a photoinitiator. The pressure-sensitive adhesive binder includes a copolymer of acrylic monomers, and a low molecular weight acrylate bonded to the copolymer, the low molecular weight acrylate having at least one pendent carbon-carbon double bond.

### BACKGROUND OF THE INVENTION

1. Field of the Invention

Embodiments relate to a photocurable composition for the formation of pressure-sensitive adhesive layer, and dicing tape produced using the same.

2. Description of the Related Art

Packaging an individual chip, i.e., die, such as an optical or semiconductor chip cut from a wafer containing many of such chips, may include dicing the wafer using a dicing tape attached thereto, removing the individual chip from the dicing tape, and bonding the chip to a next-level substrate, e.g., a lead frame, an interposer, a printed circuit board, etc. It may be desirable for the dicing tape to exhibit high initial adhesion, so as to prevent the formation of cracks in the chip during dicing. It may also be desirable for the dicing tape to be UV-sensitive, such that irradiation with UV light effects a reduction in adhesive force, i.e., tack or peel strength, in the dicing tape. In this regard, reducing the tack level using UV irradiation may make it easy to pick up the individual chips from the dicing tape by UV-irradiating the dicing tape after the wafer has been diced.

### SUMMARY OF THE INVENTION

Embodiments are therefore directed to a photocurable composition for the formation of pressure-sensitive adhesive layer, and dicing tape produced using the same, which substantially overcome one or more of the problems due to the limitations and disadvantages of the related art.

It is therefore a feature of an embodiment to provide a photocurable composition including a pressure-sensitive adhesive binder that includes a copolymer of acrylic monomers, and a low molecular weight acrylate bonded to the copolymer, the low molecular weight acrylate having at least one pendent carbon-carbon double bond.

It is therefore another feature of an embodiment to provide a dicing tape including a pressure sensitive adhesive layer formed using the photocurable composition.

At least one of the above and other features and advantages may be realized by providing a photocurable composition for a pressure-sensitive adhesive layer, the composition including a pressure-sensitive adhesive binder that includes a copolymer of acrylic monomers, and a low molecular weight acrylate bonded to the copolymer, the low molecular weight acrylate having at least one pendent carbon-carbon double bond, a reactive acrylate having a silicone backbone, a thermal curing agent, and a photoinitiator. The reactive acrylate may have a weight average molecular weight of about 1,000 or more, and the composition may include about 0.01 to about 5 parts by weight of the reactive acrylate per 100 parts by weight of the pressure-sensitive adhesive binder.

The reactive acrylate may include dimethylsiloxane units in the backbone. The reactive acrylate may be represented by Formula 1:

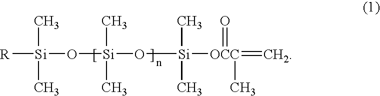

In Formula 1, R may be an aliphatic or aromatic group and n may be an integer from about 5 to about 1,000. The reactive acrylate may have a weight average molecular weight of about 1,000 to about 100,000. The low molecular weight acrylate may be bonded the copolymer of acrylic monomers by a urethane linkage. The low molecular weight acrylate may include one or more of a methacryloyl moiety, a 2-methacryloyloxyethyl moiety, or a m-isopropenyl-dimethylbenzyl moiety. Each of the acrylic monomers in the copolymer of acrylic monomers may have a hydroxyl group, a carboxyl group, an epoxy group, or an amine group.

The copolymer of acrylic monomers may be a copolymer of one or more of butyl acrylate, 2-ethylhexyl acrylate, acrylic acid, 2-hydroxyethyl (meth)acrylate, methyl (meth)acrylate, styrenic acrylate monomers, glycidyl (meth)acrylate, isooctyl acrylate, stearyl methacrylate, dodecyl acrylate, decyl acrylate, vinyl acetate, or acrylonitrile.

The pressure-sensitive adhesive resin may have a glass transition temperature of about −60° C. to about 0° C. The pressure-sensitive adhesive binder may have a weight average molecular weight of about 100,000 to about 2,000,000. The composition may include about 0.1 to about 10 parts by weight of the thermal curing agent per 100 parts by weight of the pressure-sensitive adhesive binder, and about 0.01 to about 5 parts by weight of the photoinitiator per 100 parts by weight of the pressure-sensitive adhesive binder.

The thermal curing agent may include one or more compounds containing isocyanate groups configured to react with functional groups of the pressure-sensitive adhesive binder. The photoinitiator may include one or more of a benzophenone, an acetophenone, or an anthraquinone.

At least one of the above and other features and advantages may also be realized by providing a dicing tape comprising a pressure-sensitive adhesive layer formed using the photocurable composition according to an embodiment.

The dicing tape may include a base film, the pressure-sensitive adhesive layer on the base film, and a protective release film on the pressure-sensitive adhesive layer. The dicing tape may have a maximum wafer peel strength of 0.05 N/25 mm or less after UV irradiation.

At least one of the above and other features and advantages may also be realized by providing a method of forming a photocurable composition for a pressure-sensitive adhesive layer, the method including forming a pressure-sensitive adhesive binder that includes a copolymer of acrylic monomers, and a low molecular weight acrylate bonded to the copolymer, the low molecular weight acrylate having at least one pendent carbon-carbon double bond, and combining the pressure-sensitive adhesive binder with a reactive acrylate having a silicone backbone, a thermal curing agent, and a photoinitiator. The reactive acrylate may have a weight average molecular weight of about 1,000 or more, and the composition may include about 0.01 parts or more of the reactive acrylate per 100 parts by weight of the pressure-sensitive adhesive binder.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic cross-sectional view of a dicing tape according to an embodiment.

FIG. 2 illustrates a schematic cross-sectional view of an operation of mounting a wafer to the dicing tape of FIG. 1;

FIG. 3 illustrates a schematic cross-sectional view of an operation of dicing the wafer of FIG. 2;

FIG. 4 illustrates a schematic cross-sectional view of an operation of picking up wafer chips produced by dicing the wafer in FIG. 3;

FIG. 5 illustrates a schematic cross-sectional view of an operation of bonding the wafer chips to a next-level substrate;

FIG. 6 illustrates Table 1 summarizing physical properties of materials prepared according to embodiments; and

FIG. 7 illustrates Tables 2-1 and 2-2 summarizing the composition of a PSA binder, and Examples and Comparative Examples prepared using the PSA binder.

### DETAILED DESCRIPTION OF THE INVENTION

Korean Patent Application No. 10-2007-0088323, filed on Aug. 31, 2007, in the Korean Intellectual Property Office, and entitled: “Photocurable Composition for the Formation of Pressure-Sensitive Adhesive Layer and Dicing Tape Produced Using the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B, and C together, whereas the expression “either A, B, or C” means one of A alone, B alone, and C alone, and does not mean any of both A and B together; both A and C together; both B and C together; and all three of A, B, and C together.

As used herein, the terms “a” and “an” are open terms that may be used in conjunction with singular items or with plural items. For example, the term “a thermal curing agent” may represent a single compound, e.g., hexamethylene diisocyanate, or multiple compounds in combination, e.g., hexamethylene diisocyanate mixed with isophorone diisocyanate.

As used herein, molecular weights of polymeric materials are weight average molecular weights, unless otherwise indicated.

As used herein, the language “parts by weight, based on the total amount of the photocurable composition” is exclusive of solvent, unless otherwise indicated. That is, as used herein, the point of reference “the total amount of the photocurable composition” does not include solvent. For example, where a composition is composed of two components A and B, with A present in 35 parts by weight and B present in 65 parts by weight, based on the total amount of the photocurable composition, the addition of 10 parts by weight of solvent to the composition would result in the composition continuing to have 35 parts by weight A and 65 parts by weight B, based on the total amount of the photocurable composition.

Embodiments are directed to a photocurable composition for the formation of a pressure-sensitive adhesive layer (‘PSA layer’), and a dicing tape produced using a base film and the photocurable composition. The dicing tape includes a PSA layer formed using the photocurable composition. The photocurable composition may include an intrinsic pressure-sensitive adhesive binder (‘PSA binder’) (A), a reactive acrylate (B), a thermal curing agent (C), and a photoinitiator (D).

In a typical semiconductor manufacturing process, large-diameter circuit-designed wafers may undergo stepwise processing whereby the wafers are separated into smaller chips by dicing and the chips are adhered to support members, such as PCBs and lead frame substrates, by bonding. During such processing, a dicing tape may be mounted on the back surface of a wafer (mounting operation), the wafer may then be cut into chips having a predetermined size while adhered to the dicing tape (dicing operation), the dicing tape with the diced chips thereon may be irradiated with UV light (UV irradiation operation), the individual chips may lifted from the dicing tape (pick-up operation), and the picked-up chips may be adhered to the respective support members (die bonding operation). The dicing tape attached to the back surface of the wafer in the mounting operation may firmly support the wafer, i.e., prevent the wafer from moving, due to the high adhesive force of the pressure-sensitive adhesive of the dicing tape. The dicing tape may help reduce or prevent the formation of cracks, e.g., on the surfaces and lateral sides of the chips, as a result of the dicing blade. Further, the dicing tape may provide an expandable film, which, during the pick-up operation, makes the pick-up of the chips easier.

UV irradiation type dicing tapes are generally used to pick up large-sized chips formed from thin wafers in the semiconductor manufacturing process. After dicing the chips, the UV irradiation type dicing tape may be irradiated with UV at the rear side of the dicing tape. The UV irradiation may cure the PSA layer of the dicing tape, thus reducing the peel strength at the interface between the PSA layer and the wafer, and making it easy to pick up the individual chips. To package the individual chips, i.e., for the connection of electrical signals after the dicing step, the chips are generally adhered to the support member, e.g., a next-level substrate such as a PCB or lead frame substrate. For example, a liquid epoxy resin may be introduced on the support member and the individual chip may be adhered to the support member by the epoxy resin.

Chips are becoming lighter in weight and smaller in size and thickness. In recent years, wafers as thin as 80 μm have been developed and produced. Chips formed from thin wafers may be damaged even by a small external impact during the pick-up operation. Efforts to reduce chip damage may include, e.g., adjusting processing parameters of pick-up/die bonding equipment. Such processing parameters may include the amount of expansion of the base film, the number of pins, pin ascending height and rate, pressure reduction, types of collets, etc. Among these, the pin ascending height and rate may be significant parameters for the control of the pick-up operation. However, as the thickness of chips decreases, the adjustment range of the two parameters may be greatly decreased. If the ascending height of pins is increased to facilitate the pick-up of chips, relatively thin chips may be prone to cracking, and such damage may cause serious problems in reliability after packaging. Accordingly, dicing tapes for use in the pick-up of wafers as thin as 80 μm preferably have a much lower peel strength after UV curing, i.e., the force needed to remove the dicing tape from the diced chips is much lower after UV curing, as compared to conventional dicing tapes. The low peel strength of the dicing tape after UV irradiation facilitates the pick-up of thin chips. The pick-up performance for wafers as thin as 80 μm can be experimentally determined. Also, the pick-up performance can be indirectly estimated by laminating a dicing tape to a wafer, curing the laminate by UV irradiation, and measuring the peel strength of the cured laminate. The peel strength can be measured using, e.g., a universal tensile tester or a Heidon tester (Shinto Scientific Co., Ltd. (Japan)). In a peel strength curve determined during testing, a peak may observed at the initial stage of peeling, i.e., at a yield point. Thereafter, the curve may remain constant in a predetermined zone. Accordingly, the average peel strength and the maximum peel strength between a dicing tape and a wafer should be separately expressed. When both the average and maximum peel strength factors are low, pick-up may be more easily performed using thin wafers. The maximum peel strength corresponds to interlocking, details of which will be described below. Accordingly, a decrease in maximum peel strength corresponds to a reduction of interlocking, which is desirable to minimize pick-up defects in thin wafers, e.g., 80 μm wafers.

In the photocurable composition according to an embodiment, the reactive acrylate (B) may be, e.g., a silicone-modified acrylate. The reactive acrylate may impart release and slip properties to the PSA binder (A) to prevent the occurrence of interlocking. Thus, the maximum peel strength between the PSA layer and a thin wafer may be lowered to ensure pick-up performance that is appropriate for the thin wafer. In particular, no interlocking at the interface between the dicing tape PSA binder (A) and the wafer may occur after UV irradiation, such that the maximum peel strength between the PSA layer and the thin wafer is significantly lowered, and the pick-up performance for the thin wafer is improved.

In accordance with an embodiment, there is provided a dicing tape including a pressure-sensitive adhesive (PSA) layer formed using the photocurable composition according to an embodiment. The dicing tape may have a structure in which the PSA layer is formed on one surface of a base film. Another film serving as a release film may be laminated on the PSA layer to protect it. An example embodiment of the dicing tape will now be explained in detail.

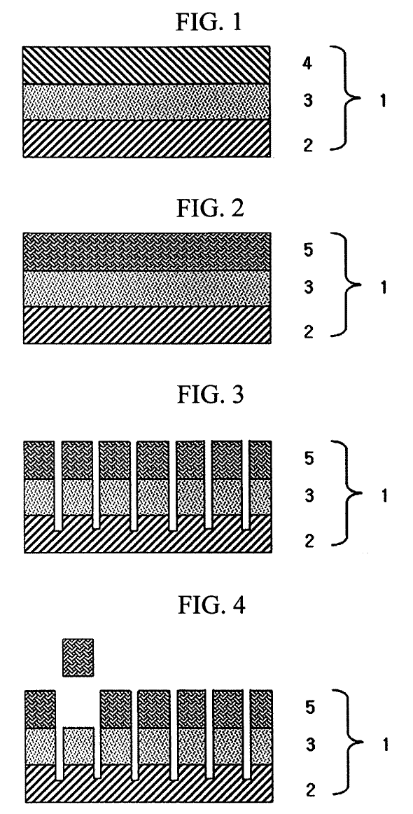

FIG. 1 illustrates a schematic cross-sectional view of a dicing tape 1 according to an embodiment. Referring to FIG. 1, the dicing tape 1 may include an expandable base film 2, a pressure-sensitive adhesive (PSA) layer 3 formed on one surface of the base film 2, and a release film 4 laminated on the PSA layer 3 to protect the PSA layer 3. The base film 2 may support the PSA layer 3 and prevent an overlying wafer from moving during dicing. The base film 2 may be made of a material, e.g., a polyolefin film, that is stretchable at room temperature so as to increase the intervals between chips after dicing, i.e., during the expansion operation. Thus, the stretchable base film 2 facilitates the picking up of the individual chips after dicing. The outermost release film 4 is used to protect the PSA layer 3 against impurities and to wind the dicing tape 1 in a roll form.

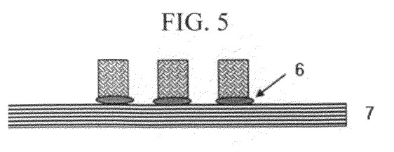

FIG. 2 illustrates a schematic cross-sectional view of an operation of mounting a wafer to the dicing tape of FIG. 1, and FIG. 3 illustrates a schematic cross-sectional view of an operation of dicing the wafer of FIG. 2. Referring to FIG. 2, the illustration shows a state in which the release film 4 has been removed from the dicing tape 1 and a wafer 5 is laminated on the PSA layer 3 by a mounting operation. Referring to FIG. 3, the illustration shows a state in which the wafer has been cut into individual small chips using a blade by a wafer dicing operation. As shown in FIG. 3, portions of the base film 2 may also be removed by the blade. FIG. 4 illustrates a schematic cross-sectional view of an operation of picking up wafer chips produced by dicing the wafer in FIG. 3. FIG. 4 shows a state in which the individual diced chips are lifted up and removed from the PSA layer 3 using a collet (pick-up operation). FIG. 5 illustrates a schematic cross-sectional view of an operation of bonding chips to next-level substrate 7. FIG. 5 shows a state in which a liquid epoxy 6 has been attached to a next-level substrate 7 to package the picked-up chips during a die bonding operation.

The PSA layer 3 of the dicing tape 1 should be firmly adhered to the wafer 5 and resulting chips, as well as to a ring frame, before UV irradiation. If the interfacial adhesion between the wafer 5 and the PSA layer 3 before UV irradiation is not large, the chips may inadvertently be peeled off of the PSA layer 3 during dicing, and the dicing tape 1 may be partially curled. The peeling off and partial curling may cause the chips to move, posing a danger of chip damage, e.g., chip cracks, chip flying, etc.

During the expansion operation, a tension may be applied to the base film 2 while fixing the ring frame, thus expanding the base film 2. At this time, poor adhesion between the PSA layer 3 and the ring frame may result in the PSA layer 3 becoming detached from the ring frame, resulting in damage to the diced chips.

Preferably, the PSA layer 3 becomes more rigid and cohesive due to crosslinking after UV irradiation so that the interfacial peel strength between the PSA layer 3 and the overlying wafer 5 is considerably decreased after UV irradiation. As the peel strength is decreased, the chips are easier to pick up. The PSA layer 3 should have an adhesive strength that is high enough to firmly hold the chips during the dicing operation. Subsequently, the adhesive strength should be markedly reduced during the pick-up operation, in order to allow the chips to be safely transferred to the die bonding operation. Thus, the PSA layer 3 should have two contrary physical properties, i.e., before and after UV irradiation.

The production of the dicing tape using the UV-curable PSA composition may be achieved using an application process. Any suitable application process that is useful in forming a uniform coating may be used without limitation, and examples thereof include bar coating, spray coating, gravure coating, comma coating, and dip coating. In another implementation, the PSA layer 3 may be coated on a release film (not shown) and then transferred to the base film 2.

After application, the coating may be dried, e.g., using heat. The PSA layer 3 may be aged at a specific temperature for a predetermined period of time. In general, curing of the PSA layer 3 may continue for some time, even after the thermal curing. Accordingly, it is preferable to age the PSA layer 3 under conditions where time-dependent variations in the stability of the coating are minimized.

The PSA layer 3 preferably has a thickness of about 2 μm to about 50 μm, more preferably about 5 μm to about 30 μm. A PSA layer 3 of about 5 μm or more may be helpful to ensure good adhesion of the PSA layer 3 to the ring frame. A PSA layer 3 of about 30 μm or less may exhibit a significant reduction in adhesion between the PSA layer 3 and the wafer 5 upon UV irradiation.

A dicing tape according to an embodiment may include a PSA layer formed using the PSA binder (A) and the reactive acrylate (B), e.g., a reactive acrylate containing dimethylsiloxane units in the molecular backbone. The maximum peel strength between the PSA layer and a wafer may be 0.05 N/25 mm or less. At a maximum peel strength of 0.05 N/25 mm or less, no interlocking may occur, such that defects are reduced or eliminated.

The PSA layer should be strongly adhered to the overlying wafer, i.e., the PSA layer should exhibit high tack, before UV irradiation. Further, the PSA layer should be strongly adhered to the ring frame in order to prevent permeation of moisture during washing and drying in the dicing operation. Further, the tack of the PSA layer should remain high to prevent the ring frame from becoming delaminated during high expansion of the base film. Further, the PSA layer should be formed of a material that becomes highly cohesive and is shrunk by crosslinking upon UV irradiation, so as achieve markedly reduced adhesion at the interface with the wafer to allow the individual chips to be picked up easily.

### Dicing Tape Base Film

The base film of the dicing tape may be made of various plastics, particularly thermoplastic plastics. Thermoplastic plastics may be preferable because such thermoplastic films may be expanded after the dicing operation to enable pick-up of the chips. Also, any chips remaining after the expansion step may again be picked up in a subsequent step. Thus, the thermoplastic film may be advantageous for its ability to restore.

The base film is preferably expandable and UV transmissive. When a UV-curable pressure-sensitive adhesive (PSA) composition is used to form the PSA layer, it is preferable that the base film is highly transmissive at UV wavelengths where the PSA composition is curable. In an implementation, the base film is free or substantially free of any compounds that absorb UV light in the wavelengths being used.

Polymeric materials used for the base film may include polyolefins, such as polyethylene, polypropylene, ethylene/propylene copolymers, polybutene-1, ethylene/vinyl acetate copolymers, polyethylene/styrenebutadiene rubber mixtures, and polyvinyl chloride. Other examples include plastics, such as polyethylene terephthalate, polycarbonate, and polymethylmethacrylate, thermoplastic elastomers, such as polyurethane and polyamide-polyol copolymers, and mixtures thereof. The base film may include two or more layers to provide improved machinability and expandability during the dicing step.

The base film may be made by blending polyolefin chips, melting the blend, and extruding or blowing the molten blend. The heat resistance and mechanical properties of the film may be controlled by the kind of polyolefin chips used. Preferably, the polyolefin film has a haze value of at least 85, e.g., wherein one surface of the polyolefin film is embossed to cause haze by light scattering. If a film having a haze value of less than 85 in a pre-cut state is laminated to one surface of a wafer in a semiconductor manufacturing process, an error may occur in recognizing the position of the film, which may interrupt processing. Embossing may also prevent jams during the production of the base film, thus enabling winding of the base film.

The PSA layer may be formed on the surface opposite to the embossed surface of the base film. The opposite surface of the base film is preferably modified to improve the adhesion to the PSA layer. The surface modification can be conducted by various physical methods (e.g., corona and plasma treatment) and chemical methods (e.g., in-line coating and primer treatment). In a preferred implementation, the surface of the base film is surface-modified by corona discharge treatment, after which the PSA layer is coated thereon.

The thickness of the base film may be determined taking into consideration factors such as elongation, workability, and UV transmittance. The base film preferably has a thickness of about 30 μm to about 300 μm, more preferably about 50 μm to about 200 μm. A thickness of about 30 μm or more may help ensure good workability in a pre-cut state, and may reduce or eliminate deformation caused by heat generated upon UV irradiation. A thickness of about 300 μm or less may avoid the need to apply an excessively large force in the expansion operation, thereby simplifying the expansion equipment and reducing costs.

### Dicing Tape PSA Layer

As noted above, the photocurable composition may include a PSA binder (A), a reactive acrylate (B), a thermal curing agent (C), and a photoinitiator (D). The PSA binder (A) may include a pressure-sensitive adhesive polymer resin (‘PSA polymer resin’) (A1), and a low molecular weight acrylate (A2). The low molecular weight acrylate (A2) may have a pendent carbon-carbon double bond providing a UV-curing function with side chains of the PSA polymer resin (A1). The reactive acrylate (B) may contain dimethylsiloxane units in the molecular backbone.

In an implementation, the photocurable composition may include 100 parts by weight of the PSA binder (A), about 0.01 to about 5 parts by weight of the reactive acrylate (B), about 0.1 to about 10 parts by weight of the thermal curing agent (C), and about 0.01 to about 5 parts by weight of the photoinitiator (D).

### PSA Layer: PSA Binder Component

In the PSA binder (A), the low molecular weight acrylate (A2) containing a carbon-carbon double bond may be introduced into the side chains of the PSA polymer resin (A1) by chemical reaction, such that the PSA binder (A) behaves as one molecule and has a plurality of pendent carbon-carbon double bonds able to undergo further reaction, e.g., upon UV irradiation during a wafer dicing operation. The PSA binder (A) is designed such that the problem of incompatibility arising from the physical mixing of a PSA polymer resin (A1) and a low molecular weight UV-curable material, and the transfer of the low molecular weight acrylate (A2) to a wafer, may be solved.

In an implementation, the PSA binder (A) may be prepared through a two-step procedure: (1) preparation of a PSA polymer resin (A1) by polymerization, and (2) addition of the low molecular weight acrylate (A2) having a reactive moiety and a pendent carbon-carbon double bond to the PSA polymer resin (A1).

### PSA Binder: PSA Polymer Resin Component and Low Molecular Weight Acrylate Component

The PSA polymer resin (A1) may be selected from various resins, such as acrylic, polyester, urethane, silicone, and natural rubber resins. An acrylic resin is preferred because of its high cohesive strength and good heat resistance. A functional group of the low molecular weight acrylate (A2) may be easily introduced into the side chains of the acrylic resin.

The acrylic PSA polymer resin (A1) may be prepared by copolymerization of constituent acrylic monomers. Examples of such acrylic monomers include butyl acrylate, 2-ethylhexyl acrylate, acrylic acid, 2-hydroxyethyl (meth)acrylate, methyl (meth)acrylate, styrenic acrylate monomers, glycidyl (meth)acrylate, isooctyl acrylate, stearyl methacrylate, dodecyl acrylate, decyl acrylate, vinyl acetate, and acrylonitrile. The PSA polymer resin (A1) may be prepared by solution polymerization, e.g., by adding the monomeric ingredients dropwise to a suitable solvent at reflux. The reaction conditions may be appropriately varied taking into consideration various factors such as molecular weight, degree of polymerization, and molecular weight distribution.

The glass transition temperature of the acrylic resin is preferably between about −60° C. and about 0° C. and, more preferably, between about −40° C. and about −10° C. An acrylic resin having a glass transition temperature lower than −40° C. is highly adhesive but may render the PSA layer weak. An acrylic resin having a glass transition temperature higher than −10° C. may only have low adhesiveness at room temperature, which may lead to poor adhesion to the wafer or the ring frame, resulting in chip flying and/or detachment of the ring frame in the expansion operation. The kind and content of the monomers may be controlled to limit the glass transition temperature of the acrylic PSA polymer resin (A1) to the range noted above.

The acrylic PSA polymer resin (Al) may be prepared by copolymerization of a combination of various kinds of monomers. The glass transition temperature of the copolymer may be determined by the mixing ratio of the selected monomers. The monomers may be divided into two groups: monomers with a functional group and monomers without functional groups. At least one monomer having a functional group selected from hydroxyl, carboxyl, epoxy, and amine groups capable of addition reaction is important for the attachment to the surface of a polyolefin film, which is an apolar polymer film. Low molecular weight monomers having a UV-curable double bond are important for the introduction into the side chains of the polymer resin.

The low molecular weight acrylate (A2) having a functional group and a pendent carbon-carbon double bond may be reacted with the PSA polymer resin (A1). At this time, the functional group of the low molecular weight acrylate (A2) reacts with the functional groups in the side chains of the PSA polymer resin (A1), so that the low molecular weight acrylate (A2) is introduced into the side chains of the PSA polymer resin (A1). Exemplary combinations of the functional groups that can be used for the addition reaction of the low molecular weight acrylate (A2) and the PSA polymer resin (A1) to prepare the PSA binder (A) include combinations of highly reactive functional groups, such as a combination of carboxyl and epoxy groups, a combination of hydroxyl and isocyanate groups, and a combination of carboxyl and amine groups. In view of reactivity and reaction tracing, a combination of hydroxyl and isocyanate groups is most preferred.

Preferably, the PSA polymer resin (Al) contains functional groups such as hydroxyl and carboxyl groups. The functional groups should remain in the PSA polymer resin (A1) even after the addition reaction. Accordingly, the hydroxyl and acid values of the PSA binder (A) should be maintained constant. In a preferred implementation, a urethane reaction between hydroxyl and isocyanate groups is carried out for the addition reaction. The addition reaction between carboxyl and epoxy groups, or between carboxyl and amine groups, may proceed only at a relatively high temperature, i.e., heating may be required to introduce the low molecular weight acrylate (A2) having a carbon-carbon double bond into the side chains of the polymer resin. However, the carbon-carbon double bonds may be cleaved due to the high reaction temperature during the addition reaction, leading to crosslinking and gelling, and making it difficult or impossible to obtain the desired PSA binder (A).

The low molecular weight acrylate (A2) may be partially polymerized when the addition reaction is carried out under heat to increase the yield of the PSA binder (A). A hydroquinone compound may be added as a polymerization inhibitor to increase the yield of the addition reaction while maintaining the carbon-carbon double bonds intact. The addition reaction between carboxyl and epoxy groups, or between carboxyl and amine groups, is less reactive than that between hydroxyl and isocyanate groups. In the former case, it is difficult to introduce the low molecular weight acrylate (A2) having a carbon-carbon double bond into the side chains of the polymer resin. Accordingly, the number of carbon-carbon double bonds introduced into the side chains of the polymer resin may be relatively small, such that the resulting composition does not exhibit a marked reduction in peel strength between the PSA layer and the wafer after UV irradiation.

The low molecular weight acrylate (A2) may be used in excess due to its low reaction conversion rate, but a portion of the low molecular weight acrylate (A2) may then remain unreacted in the mixed solution. The remaining portion of the low molecular weight acrylate (A2) is left within the PSA layer, and thereafter, it slowly rises to the surface of the PSA layer with the passage of time to form a band of the low molecular weight material in the form of an oil band. When the wafer is laminated on the PSA layer the low molecular weight acrylate (A2) may be slowly transferred to the overlying wafer. The low molecular weight acrylate (A2) transferred to the wafer becomes a source of contamination in a subsequent packaged semiconductor device.

In a preferred embodiment, a urethane reaction mechanism is employed to add the UV-curable low molecular weight acrylate (A2) to the side chains of the acrylic PSA polymer resin (A1). The PSA binder (A) may be designed based on the reactivity of hydroxyl and isocyanate groups. Two reaction mechanisms for the urethane bonding are 1) introduce an acrylate having an isocyanate group into the side chains of an acrylic PSA polymer resin (A1) having hydroxyl groups, and 2) introduce an acrylate having a hydroxyl group into the side chains of an acrylic PSA polymer resin (A1) having isocyanate groups. The latter mechanism may be undesirable. For example, when an acrylate having an isocyanate group is mixed and polymerized with other monomers, the choice of solvents and monomers used may be limited due to high reactivity of the isocyanate group. Further, since an acrylic PSA polymer resin (A1) having isocyanate groups in the side chains, which is prepared by the copolymerization, is highly reactive, it may react with moisture or other hydroxyl compounds during storage, resulting in damage.

The low molecular weight acrylate (A2) having a pendent carbon-carbon double bond and an isocyanate group may include, e.g., methacryloyl isocyanate, 2-methacryloyloxyethyl isocyanate or m-isopropenyl-dimethylbenzyl isocyanate. The low molecular weight acrylate (A2) may have a molecular weight of about less than 1000. For example, the molecular weight of the low molecular weight acrylate (A2) may be, e.g., about 155 g/mol in the case of 2-methacryloyloxyethyl isocyanate.

The PSA binder (A) may have a weight average molecular weight of about 100,000 to about 2,000,000. A PSA binder (A) having a weight average molecular weight lower than about 100,000 may, when coated on the base film, form a coating with poor adhesive and cohesive strengths. The coating may be easily delaminated from the base film by the dicing blade, thus causing chips to fly off or crack. A PSA binder (A) having a weight average molecular weight higher than about 2,000,000 may be substantially insoluble in a solvent, leading to poor processability, e.g., poor coatability. The weight average molecular weight of the PSA binder (A) may be partially determined when preparing the base polymer, and may be slightly increased through the addition reaction.

### PSA Layer: Reactive Acrylate Component

In an embodiment, the reactive acrylate (B) has a structure represented by Formula 1:

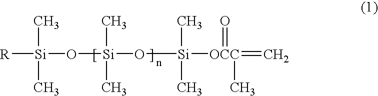

In Formula 1, R may be an aliphatic or aromatic group, and n may be an integer from about 5 to about 1,000.

The presence of the intramolecular dimethylsiloxane units in the reactive acrylate (B) may help ensure good release properties from organic and inorganic materials. The methyl groups of the dimethylsiloxane units function as a polar molecules when in contact with the surface of an adherend. These structural features allow the reactive acrylate (B) to have excellent release and slip properties with respect to polar organic and inorganic adherends. The terminal carbon-carbon double bond of the reactive acrylate (B) is activated by UV irradiation and participates in crosslinking. In addition, the dimethylsiloxane units present in the molecular chain of the reactive acrylate (B) help impart excellent release properties to the PSA layer after UV curing to make the PSA layer slippery against a wafer. As a result, no interlocking between the PSA layer and the wafer takes place during UV curing, and the maximum peel strength between the PSA layer and the wafer may be lowered to about 0.05 N/25 mm or less.

In Formula 1, R may be an aliphatic or aromatic group. Preferably, the reactive acrylate (B) has a weight average molecular weight of about 1,000 to about 100,000. A reactive acrylate (B) having a weight average molecular weight lower than about 1,000 may be transferred from the PSA layer to the surface of the wafer, which may negatively affects the reliability of the final product. A reactive acrylate (B) having a weight average molecular weight greater than about 100,000 may be incompatible with the PSA binder (A) because of its main silicone structure, resulting in poor coatability of the photocurable composition.

It is preferable to use the reactive acrylate (B) in an amount of about 0.01 to about 5 parts by weight, based on 100 parts by weight of the PSA binder (A). The use of the reactive acrylate (B) in an amount of less than about 0.1 parts by weight, i.e., if the absolute amount of the dimethylsiloxane units is small, may not impart the desired release properties and slip properties to the photocurable composition. As a result, interlocking may occur on the surface of a wafer upon UV irradiation, and the maximum peel strength between the PSA layer and the wafer may be increased, e.g., to above 0.1 N/25 mm. Further, defects may be observed in picking up a wafer as thin as 80 μm. Although the use of the reactive acrylate (B) in an amount of more than about 5 parts by weight is not likely to causes problems in slip properties after UV curing, slip properties may be exhibited even before UV curing due to the presence of the dimethylsiloxane units, leading to very low peel strength between the PSA and a wafer before UV curing. As a result, the wafer may be moved by the dicing blade during dicing, causing chipping and chip cracks, and resulting in poor processability. In addition, the photocurable composition may not be readily attached to the ring frame, and the PSA layer may be delaminated from the ring frame during expanding resulting in the occurrence of defects over the entire region of the wafer.

### PSA Layer: Thermal Curing Agent Component

The PSA binder (A) is preferably prepared through an addition reaction between hydroxyl and isocyanate groups. When the PSA binder (A) is a copolymer of an acrylate having at least one hydroxyl group, the thermal curing agent (C) may contain isocyanate groups. When the PSA binder (A) contains a functional group other than a hydroxyl group, compounds such as melamine/formaldehyde resins and epoxy resins can be used alone or as a mixture thereof.

The thermal curing agent (C) functions as a crosslinking agent that reacts with the functional groups of the PSA binder (A), and crosslinks with the PSA binder (A) to form a three-dimensional network structure. By the addition of the curing agent (C), a rigid coating may be formed on the surface of a base film 2 without being delaminated during dicing or UV irradiation.

The thermal curing agent (C) is preferably present in an amount of about 0.01 to about 10 parts by weight, based on 100 parts by weight of the PSA binder (A). If the content of the thermal curing agent is less than 0.01 parts by weight, little or no crosslinking may occur in the photocurable composition. As a result, a coating of the photocurable composition may be delaminated from the base film due to poor adhesion of the photocurable composition to the base film. If the content of the thermal curing agent is more than about 10 parts by weight, excessive crosslinking may occur in the photocurable composition. As a result, the photocurable composition may lose its tack even before UV irradiation, causing poor adhesion of the dicing tape to the wafer, causing chips to fly off during dicing, etc. Further, the adhesion of the photocurable composition to a ring frame may be deteriorated, resulting in detachment of the dicing tape from the ring frame during expanding.

The thermal curing agent (C) is preferably a compound containing isocyanate groups. Specific examples of suitable thermal curing agents include aromatic isocyanates, such as 4,4′-diphenyl ether diisocyanate and 4,4′-[2,2-bis(4-phenoxyphenyl)propane]diisocyanate, hexamethylene diisocyanate, 2,2,4-trimethylhexamethylene diisocyanate, isophorone diisocyanate, and 4,4′-dicyclohexylmethane diisocyanate.

### PSA Layer: Photoinitiator Component

The photoinitiator (D) is preferably present in an amount of about 0.01 to about 5 parts by weight, based on 100 parts by weight of the PSA binder (A). If the content of the photoinitiator (D) is less than about 0.01 parts by weight, the radical formation efficiency of the photoinitiator (D) upon UV irradiation may be reduced, resulting in an insufficient reduction in adhesion at the interface between the PSA layer and the adherend, i.e., the diced chips. Therefore, the desired pick-up performance may not be achieved. If the content of the photoinitiator (D) is more than about 5 parts by weight, a portion of the initiator may remain unreacted, producing a smell and becoming transferred to the adherend (without further improvement in UV irradiation efficiency), thus deteriorating reliability in the packaged device.

Any suitable photopolymerization initiator may be used as the photoinitiator (D). Preferably, the photoinitiator includes one or more of benzophenones, acetophenones, anthraquinones, and mixtures thereof. Specific examples of suitable photoinitiators include: benzophenones such as benzophenone, 4,4′-dimethylaminobenzophenone, 4,4′-diethylaminobenzophenone, and 4,4′-dichlorobenzophenone; acetophenones such as acetophenone and diethoxyacetophenone; and anthraquinones such as 2-ethylanthraquinone and t-butylanthraquinone. These photopolymerization initiators may be used alone or as a mixture of two or more thereof.

### PSA Layer: Additional Components

For better solubility and storability, the photocurable composition may further comprise one or more additives, e.g., surfactants, antistatic agents, storage stabilizers, wetting agents, dispersants, and fillers. The kinds of the additives may be determined according to the intended applications and needs.

### EXAMPLES

The following Examples and Comparative Examples are provided in order to set forth particular details of one or more embodiments. However, it will be understood that the embodiments are not limited to the particular details described.

### Preparative Example 1: Preparation of Pressure-Sensitive Adhesive (PSA) Binder

6.00 kg of methyl ethyl ketone and 0.60 kg of toluene as organic solvents were put into a 20 L four-neck flask equipped with a reflux condenser, a thermometer, and a dropping funnel. The temperature of the flask was raised to 60° C. Thereafter, 3.40 kg of 2-ethylhexyl acrylate, 0.20 kg of ethyl acrylate, 0.30 kg of vinyl acetate, 0.48 kg of 2-hydroxyethyl methacrylate, 0.43 kg of acrylic acid and 0.04 kg of benzoyl peroxide were mixed together and added dropwise to the flask through the dropping funnel with stirring at 250 rpm at 60-70° C. for 3 hours. After the addition was finished, the reaction mixture was aged at the same conditions for 4 hours and then 0.20 kg of ethyl acetate and 0.01 kg of azobisisobutyronitrile (AIBN) were added thereto. The resulting mixture was allowed to stand for 4 hours and measured for viscosity and solids content. The reaction was stopped to give an acrylic PSA polymer resin (A1). The acrylic PSA polymer resin (A1) was found to have a viscosity of 15,000-20,000 cps. The solids content of the acrylic PSA polymer resin (A1) was adjusted to 45%. 0.30 kg of 2-methacryloyloxyethyl isocyanate was added to the acrylic PSA polymer resin (A1) and allowed to react at room temperature for one hour to prepare a PSA binder (A).

### Example 1

100 g of the PSA binder (A), 1 g of a reactive acrylate (X-22-164B, Shin-Etsu Chemical Co., Ltd.) having a weight average molecular weight of 1,630 g/mol, 1 g of an isocyanate curing agent (L-45, Nippon Polyurethane Industry Co., Ltd.) and 0.5 g of a photoinitiator (IC-184, Ciba-Geigy) were mixed together to prepare a UV-curable pressure-sensitive adhesive (PSA) composition. The photocurable composition was coated on one surface of a 100 μm thick polyolefin film and dried to produce a 10 μm thick dicing tape (dicing tape sample dt_a).

### Example 21

100 g of the PSA binder (A), 1 g of a reactive acrylate (X-22-164C, Shin-Etsu Chemical Co., Ltd.) having a weight average molecular weight of 2,370 g/mol, 1 g of isocyanate curing agent (L-45, Nippon Polyurethane Industry Co., Ltd.) and 0.5 g of photoinitiator (IC-184, Ciba-Geigy) were mixed together to prepare a UV-curable PSA composition. The photocurable composition was coated on one surface of a 100 μm thick polyolefin film and dried to produce a 10 μm thick dicing tape (dicing tape sample dt_b).

### Example 3

100 g of the PSA binder (A), 1 g of a reactive acrylate (X-22-174DX, Shin-Etsu Chemical Co., Ltd.) having a weight average molecular weight of 4,600 g/mol, 1 g of isocyanate curing agent (L-45, Nippon Polyurethane Industry Co., Ltd.) and 0.5 g of photoinitiator (IC-184, Ciba-Geigy) were mixed together to prepare a UV-curable PSA composition. The photocurable composition was coated on one surface of a 100 μm thick polyolefin film and dried to produce a 10 μm thick dicing tape (dicing tape sample dt_c).

### Comparative Example 1

100 g of the PSA binder (A), 1 g of isocyanate curing agent (L-45, Nippon Polyurethane Industry Co., Ltd.) and 0.5 g of photoinitiator (IC-184, Ciba-Geigy) were mixed together to prepare a UV-curable PSA composition. The photocurable composition was coated on one surface of a 100 μm thick polyolefin film and dried to produce a 10 μm thick dicing tape (dicing tape sample dt_d).

### Comparative Example 2

100 g of the PSA binder (A), 1 g of a reactive acrylate (X-22-164AS, Shin-Etsu Chemical Co., Ltd.) having a weight average molecular weight of 450 g/mol, 1 g of isocyanate curing agent (L-45, Nippon Polyurethane Industry Co., Ltd.) and 0.5 g of photoinitiator (IC-184, Ciba-Geigy) were mixed together to prepare a UV-curable PSA composition. The photocurable composition was coated on one surface of a 100 μm thick polyolefin film and dried to produce a 10 μm thick dicing tape (dicing tape sample dt_e).

### Comparative Example 3

100 g of the PSA binder (A), 0.005 g of reactive acrylate (X-22-174DX, Shin-Etsu Chemical Co., Ltd.) having a weight average molecular weight of 4,600 g/mol, 1 g of isocyanate curing agent (L-45, Nippon Polyurethane Industry Co., Ltd.) and 0.5 g of photoinitiator (IC-184, Ciba-Geigy) were mixed together to prepare a UV-curable PSA composition. The photocurable composition was coated on one surface of a 100 μm thick polyolefin film and dried to produce a 10 μm thick dicing tape (dicing tape sample dt_f).

### Comparative Example 4

100 g of the PSA binder (A), 8 g of reactive acrylate (X-22-174DX, Shin-Etsu Chemical Co., Ltd.) having a weight average molecular weight of 4,600 g/mol, 1 g of isocyanate curing agent (L-45, Nippon Polyurethane Industry Co., Ltd.) and 0.5 g of photoinitiator (IC-184, Ciba-Geigy) were mixed together to prepare a UV-curable PSA composition. The photocurable composition was coated on one surface of a 100 μm thick polyolefin film and dried to produce a 10 μm thick dicing tape (dicing tape sample dt_g).

The composition of the PSA binder (A) used in the Examples and Comparative Examples is summarized in Table 2-1. The compositions of the above-described Examples and Comparative Examples are summarized in Table 2-2.

### Tests for Physical Properties of Dicing Tapes

### Wafer Peel Strength: Measurement of 180° Peel Strength Between Wafers and Dicing Tapes (Before and After UV Curing)

The 180° peel strengths between wafers and the sample dicing tapes (dt_a to dt_g) were measured in accordance with the procedure JIS Z0237. Each of the samples was cut into test pieces having a size of 15 mm×100 mm. The dicing tape and the wafer of each of the test pieces were clamped to upper and lower jigs in a 10 N load cell of a tensile tester (Instron Series 1X/s Automated materials Tester-3343). The load required when the dicing tape was peeled from the wafer at a tensile rate of 300 mm/min was measured. The test piece was irradiated with UV using a high-pressure mercury lamp (intensity of illumination: 70 W/cm², AR 08 UV, Aaron Equip.) at an exposure dose of 140 mJ/cm² for 2 seconds. Ten samples were tested for average peel strength and maximum peel strength in each experiment, before and after UV irradiation.

### SUS Peel Strength: Measurement of 180° Peel Strength Between SUS and Dicing Tapes (Before and After UV Curing)

The 180° peel strengths between SUS (stainless steel) and the dicing tapes were measured in accordance with the procedure JIS Z0237. Each of the samples was cut into test pieces having a size of 15 mm×100 mm. The dicing tape and the SUS of each of the test pieces were clamped to upper and lower jigs in a 10 N load cell of a tensile tester (Instron Series 1X/s Automated materials Tester-3343). The load required when the dicing tape was peeled from the SUS at a tensile rate of 300 mm/min was measured. The test piece was irradiated with UV using a high-pressure mercury lamp (intensity of illumination: 70 W/cm², AR 08 UV, Aaron Equip.) at an exposure dose of 140 mJ/cm² for 2 seconds. Ten samples were tested for maximum peel strength in each experiment before and after UV irradiation.

### Tack: Tackiness Measurement Before and After UV Curing)

The tackiness of the PSA layers of the dicing tapes produced in Examples 1-3 and Comparative Examples 1-4 was measured using a probe tack tester (Chemilab Tack Tester) before and after UV curing. Using the test method ASTM D2979-71, a tip of a clean probe was brought into contact with the surface of each of the PSA layers at a rate of 10±0.1 mm/sec and a contact load of 9.79±1.01 kPa for 1.0±0.01 sec, and separated from the PSA layer. At this time, a maximum force required for the separation was defined as the tackiness value of the test piece. The test piece was irradiated with UV using a high-pressure mercury lamp (intensity of illumination: 70 W/cm², AR 08 UV, Aaron Equip.) at an exposure dose of 140 mJ/cm² for 2 seconds. Ten samples were tested for average peel strength in each experiment before and after UV irradiation.

### Pick-up Success Rate

An 8″ diameter silicon wafer (thickness: 80 μm) was pressed on each of the dicing tapes produced in Examples 1-3 and Comparative Examples 1-4 at 25° C. for 10 seconds, and then diced to a size of 16 mm×9 mm using a dicing saw (DFD-650, DISCO). Thereafter, the resulting film was irradiated with UV using a high-pressure mercury lamp (intensity of illumination: 70 W/cm², AR 08 UV, Aaron Equip.) at an exposure dose of 140 mJ/cm² for 2 seconds. A pick-up test was conducted on 200 chips positioned at a central portion of the silicon wafer using a die bonder (SDB-10M, Samsung Mechatronics), and the pick-up success rate of the chips was measured.

### Particles Transferred to Wafer

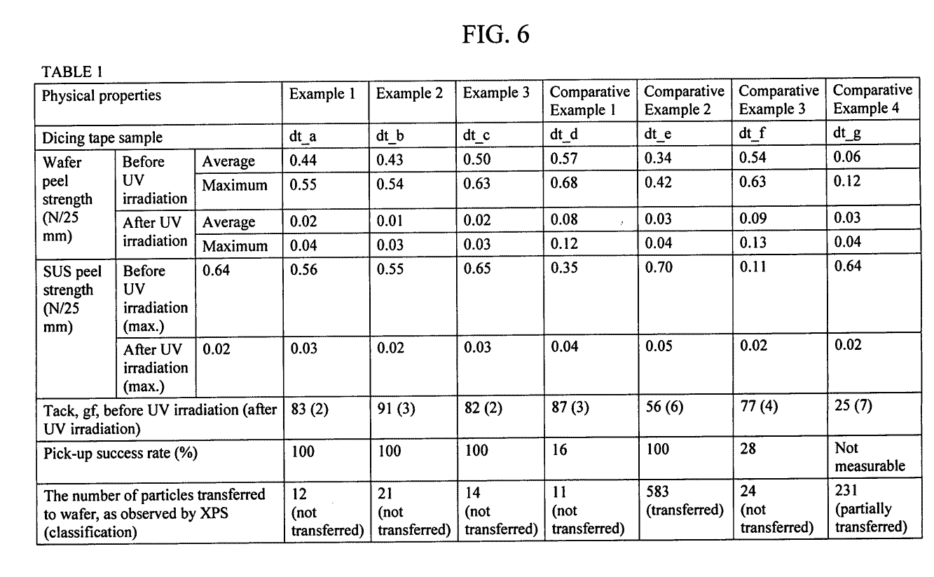

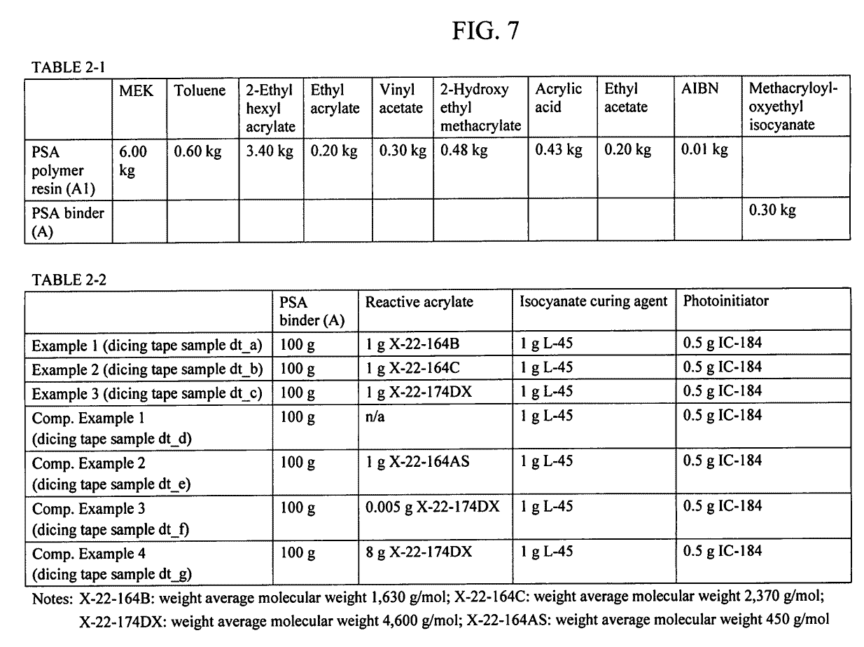

Each of the dicing tapes was adhered to the surface of an 8″ diameter wafer, irradiated with UV using a high-pressure mercury lamp (intensity of illumination: 70 W/cm², AR 08 UV, Aaron) at an exposure dose of 140 mJ/cm² for 2 seconds, and peeled off from the wafer. The number of particles having a size larger than 0.3 μm present on the wafer surface was counted by X-ray photoelectron spectroscopy (XPS). The obtained results are shown in Table 1 in FIG. 6.

The results in Table 1 show that the dicing tape produced without the use of any reactive acrylate in Comparative Example 1 had a maximum peel strength higher than 0.1 N/25 mm because of no slip properties after UV curing, indicating that interlocking was induced in the dicing tape. This interlocking led to a very low pick-up success rate of 16% for the 80 μm wafer.

No interlocking with the wafer was found for each of the dicing tapes produced in Examples 1-3, which included about 0.01 to about 5 parts by weight of the reactive acrylate having a weight average molecular weight of about 1,000 to about 100,000 with respect to 100 parts by weight of the pressure-sensitive adhesive (PSA) binder, because of the slip properties of the dimethylsiloxane units. As a result, the maximum peel strength between the PSA layer and the wafer after UV irradiation was lower than 0.05 N/25 mm and the pick-up success rate for the 80 μm wafer was 100%.

In contrast, the dicing tape produced in Comparative Example 2, which included 1 part by weight of the reactive acrylate having a weight average molecular weight lower than 1,000 g/mol and containing dimethylsiloxane units in the molecular chain had a pick-up success rate of 100%, but the low molecular weight acrylate (A2) was transferred to the wafer surface, resulting in poor reliability.

The dicing tape produced in Comparative Example 3, which included 0.005 parts by weight of the reactive acrylate having a weight average molecular weight higher than 1,000 g/mol and containing dimethylsiloxane units in the molecular chain showed no slip properties, like the dicing tape produced without the use of any reactive acrylate in Comparative Example 1. As a result, interlocking was induced at the interface between the wafer and the PSA layer. This interlocking led to a maximum peel strength higher than 0.1 N/25 mm between the wafer and the PSA layer after UV irradiation, resulting in a very low pick-up success rate.

In the dicing tape produced in Comparative Example 4, which included 8 parts by weight of the reactive acrylate having a weight average molecular weight higher than 1,000 g/mol and containing dimethylsiloxane units in the molecular chain, excess reactive acrylate increased the slip properties of the coating layer to reduce the maximum peel strength between the wafer and the PSA layer before UV irradiation as well as after UV irradiation, causing chip flying and chipping during dicing. Further, the maximum peel strength between the SUS and the PSA layer before UV irradiation was reduced to cause the ring frame to be delaminated during picking up, resulting in high defective rate.

In contrast to the performance characteristics of the embodiments described above in connection with Examples 1-3, the adhesive force of a conventional acrylic PSA used in a conventional dicing tape may remain at 80-130 g/25 mm, even 10 days after UV irradiation. Such a high adhesive force is generally unsuitable for thin wafers.

Also, a conventional photocurable pressure-sensitive adhesive composition prepared by physically mixing, rather than covalently bonding, a low molecular weight oligomer or acrylate with a pressure-sensitive adhesive polymer resin may exhibit poor pick-up performance due to the high tack of such compositions after UV irradiation. The amount of the low molecular weight acrylate that is mixed with the PSA polymer resin may be decreased in order to lower the cohesive force of the PSA binder after UV curing. In this case, however, the absolute peel strength is undesirably increased.

Further, a conventional dicing tape may be produced using a PSA binder alone. While such a dicing tape may substantially lose its tack after UV curing, it may suffer from severe shrinkage upon UV irradiation, making it difficult to pick up chips from thin wafers. In particular, because the dimensions of the wafer are not varied, the high shrinkage results in locking at the interface between the PSA binder and the wafer. This locking increases the maximum peel strength and causes defects during picking up in semiconductor manufacturing processes. For thick wafers, pin stroke may be increased sufficiently to loosen the interlocking. However, chip cracks are likely in a thin wafers, e.g., 80 μm.

As apparent from the foregoing description of the embodiments, the reactive acrylate, e.g., a silicone-modified acrylate, of the photocurable composition according to embodiments may impart release and slip properties to the PSA binder to prevent the occurrence of interlocking. Thus, sufficient pick-up performance may be ensured even with a thin wafer. In addition, since no interlocking takes place in the dicing tape after UV irradiation, the maximum peel strength between the dicing tape PSA layer and a thin wafer after dicing and UV irradiation is very low, and the pick-up performance for the thin wafer is excellent.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A photocurable composition for a pressure-sensitive adhesive layer, the composition comprising:
a pressure-sensitive adhesive binder that includes:
a copolymer of acrylic monomers; and
a low molecular weight acrylate bonded to the copolymer, the low molecular weight acrylate having at least one pendent carbon-carbon double bond;
a reactive acrylate having a silicone backbone;
a thermal curing agent; and
a photoinitiator, wherein:
the reactive acrylate has a weight average molecular weight of about 1,000 or more, and
the composition includes about 0.01 to about 5 parts by weight of the reactive acrylate per 100 parts by weight of the pressure-sensitive adhesive binder.

2. The photocurable composition as claimed in claim 1, wherein the reactive acrylate includes dimethylsiloxane units in the backbone.

3. The photocurable composition as claimed in claim 1, wherein the reactive acrylate is represented by Formula 1: 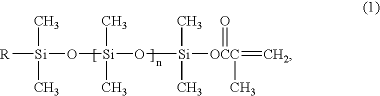
wherein R is an aliphatic or aromatic group and n is an integer from about 5 to about 1,000.

4. The photocurable composition as claimed in claim 1, wherein the reactive acrylate has a weight average molecular weight of about 1,000 to about 100,000.

5. The photocurable composition as claimed in claim 1, wherein the low molecular weight acrylate is bonded the copolymer of acrylic monomers by a urethane linkage.

6. The photocurable composition as claimed in claim 5, wherein the low molecular weight acrylate includes one or more of a methacryloyl moiety, a 2-methacryloyloxyethyl moiety, or a m-isopropenyl-dimethylbenzyl moiety.

7. The photocurable composition as claimed in claim 1, wherein each of the acrylic monomers in the copolymer of acrylic monomers has a hydroxyl group, a carboxyl group, an epoxy group, or an amine group.

8. The photocurable composition as claimed in claim 1, wherein the copolymer of acrylic monomers is a copolymer of one or more of butyl acrylate, 2-ethylhexyl acrylate, acrylic acid, 2-hydroxyethyl (meth)acrylate, methyl (meth)acrylate, styrenic acrylate monomers, glycidyl (meth)acrylate, isooctyl acrylate, stearyl methacrylate, dodecyl acrylate, decyl acrylate, vinyl acetate, or acrylonitrile.

9. The photocurable composition as claimed in claim 1, wherein the pressure-sensitive adhesive resin has a glass transition temperature of about −60° C. to about 0° C.

10. The photocurable composition as claimed in claim 1, wherein the pressure-sensitive adhesive binder has a weight average molecular weight of about 100,000 to about 2,000,000.

11. The photocurable composition as claimed in claim 1, wherein the composition includes:
about 0.1 to about 10 parts by weight of the thermal curing agent per 100 parts by weight of the pressure-sensitive adhesive binder, and
about 0.01 to about 5 parts by weight of the photoinitiator per 100 parts by weight of the pressure-sensitive adhesive binder.

12. The photocurable composition as claimed in claim 1, wherein the thermal curing agent includes one or more compounds containing isocyanate groups configured to react with functional groups of the pressure-sensitive adhesive binder.

13. The photocurable composition as claimed in claim 1, wherein the photoinitiator includes one or more of a benzophenone, an acetophenone, or an anthraquinone.

14. A dicing tape comprising a pressure-sensitive adhesive layer formed using the photocurable composition as claimed in claim 1.

15. The dicing tape as claimed in claim 14, wherein the dicing tape comprises a base film, the pressure-sensitive adhesive layer on the base film, and a protective release film on the pressure-sensitive adhesive layer.

16. The dicing tape as claimed in claim 14, wherein the dicing tape has a maximum wafer peel strength of 0.05 N/25 mm or less after UV irradiation.

17. A method of forming a photocurable composition for a pressure-sensitive adhesive layer, the method comprising:
forming a pressure-sensitive adhesive binder that includes:
a copolymer of acrylic monomers; and
a low molecular weight acrylate bonded to the copolymer, the low molecular weight acrylate having at least one pendent carbon-carbon double bond; and
combining the pressure-sensitive adhesive binder with a reactive acrylate having a silicone backbone, a thermal curing agent, and a photoinitiator, wherein:
the reactive acrylate has a weight average molecular weight of about 1,000 or more, and
the composition includes about 0.01 parts or more of the reactive acrylate per 100 parts by weight of the pressure-sensitive adhesive binder.
